(19) United States
(12) Patent Application Publication
(10) Pub. No.: US 2026/0054216 A1
(43) Pub. Date: Feb. 26, 2026

(54) CO2 PLASMA SCRUBBER SYSTEM WITH CO2 ENCAPTUREMENT

(71) Applicant: Nanoclean (S) Pte Ltd, Singapore (SG)

(72) Inventors: Chen Sau Ngen Peter, Singapore (SG); Chen Nam Hin Terence, Singapore (SG); Thomas Angelo Steiber, San Jose, CA (US)

(73) Assignee: Nanoclean (S) Pte Ltd, Singapore (SG)

(21) Appl. No.: 19/256,067

(22) Filed: Jun. 30, 2025

Related U.S. Application Data
(60) Provisional application No. 63/665,253, filed on Jun. 28, 2024.

(51) Int. Cl. B01D 53/32

(52) U.S. Cl. CPC B01D 53/32; B01D 2257/30; B01D 2257/502; B01D 2257/504; B01D 2259/818

(57) ABSTRACT

Disclosed is an apparatus for inversion exercise comprising a hang element coupled to a turntable, which is attached to a suspension framework. In embodiments, the hang element is configured to rotate with respect to the suspension framework, permitting a user to spin while hanging in either an inverted or upright position. In certain embodiments, the suspension framework may comprise a geodesic dome structure.

### CROSS-REFERENCE TO RELATED APPLICATIONS

The present invention claims priority under 35 USC 119(e) to commonly-owned US Application No. 63/665,253, by Chen Sau Ngen Peter filed Jun. 28, 2024, entitled CO2 PLASMA SCRUBBER SYSTEM WITH CO2 ENCAPTUREMENT the contents of which being hereby incorporated by reference in its entirety.

### FIELD OF THE INVENTION

The invention relates generally to a mechanical device, and more specifically, to a CO2 plasma scrubber system that combines plasma-based techniques with CO2 enrapturement.

### BACKGROUND

There is global concern over rising carbon dioxide (CO2) levels and their impact on climate change has spurred a critical need. Greenhouse gases trap Earth's radiant heat thus preventing their escape into space. The end effect is that the plant is indeed increasing in temperature daily thereby contributing to the Earth's overall greenhouse effect.

Therefore, what is needed is a CO2 plasma scrubber system that combines plasma-based techniques with unique molecular CO2 enrapturement techniques.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level perspective diagram illustrating a CO2 plasma scrubber system, according to some embodiments.

FIG. 2 is a perspective diagram illustrating a manger, and also an encapurement cartridge, according to an embodiment.

FIG. 3 is a perspective diagram illustrating a turbo plasma ionizer, according to an embodiment.

FIG. 4 is a chart illustrating mediums for absorbing CO2 on collector pads, according to an embodiment.

FIG. 5 is a chart illustrating CO2 levels affected by the scrubber system, according to an embodiment.

FIG. 6 is a chart illustrating a system for collecting, according to an embodiment.

FIGS. 7-9 are perspective views of a three manger system for collecting CO, CO2 and sulfur, according to an embodiment.

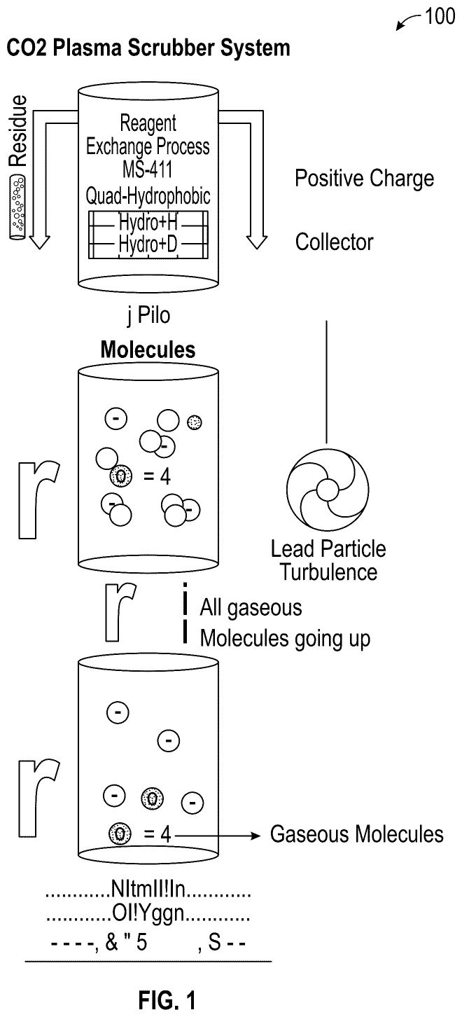

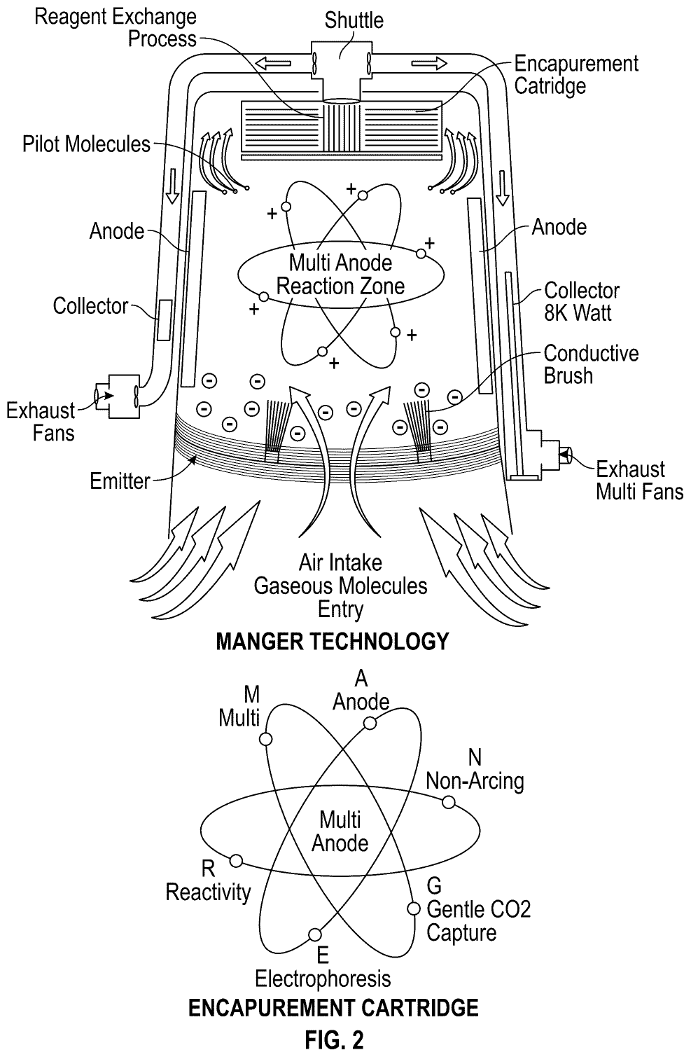

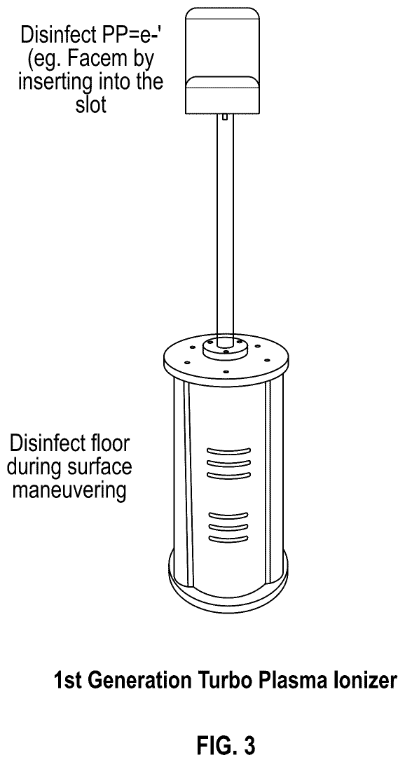

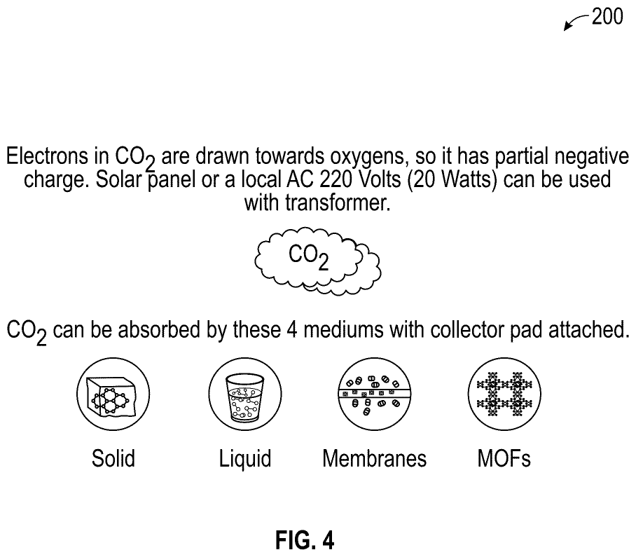

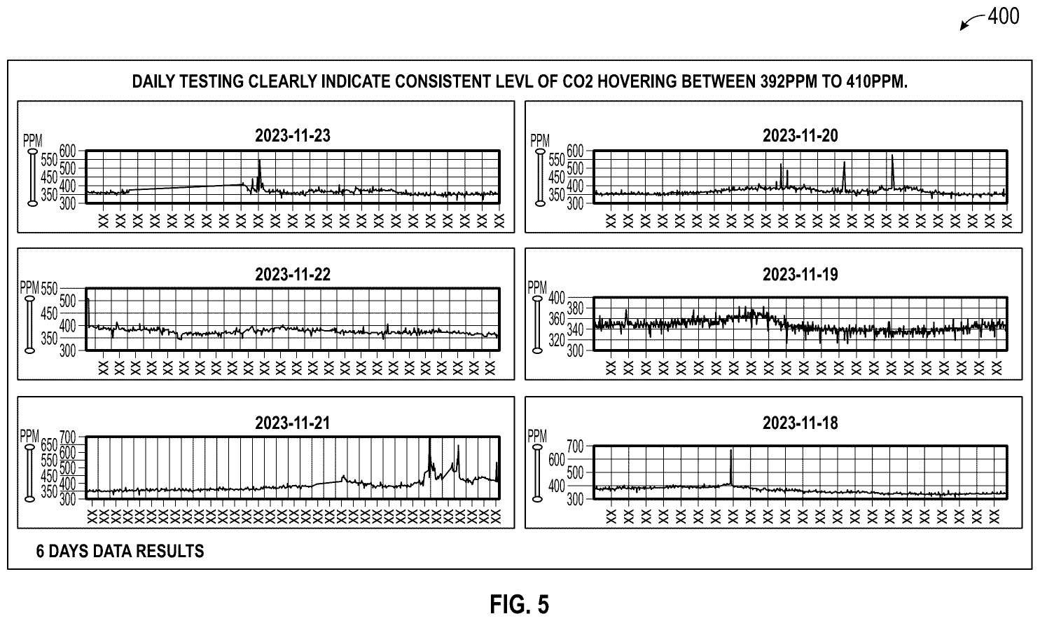

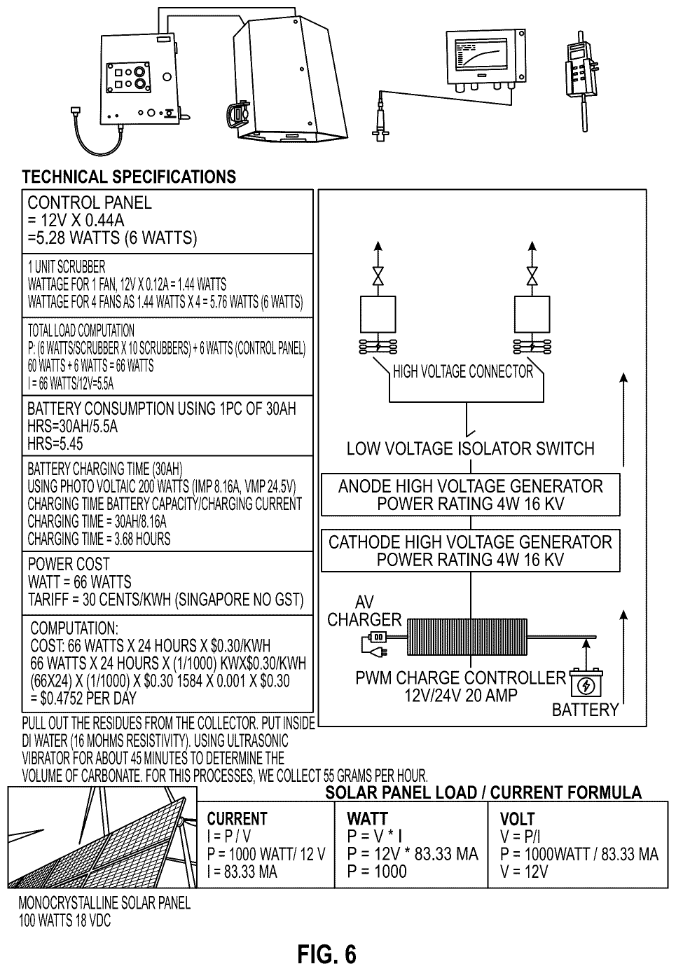

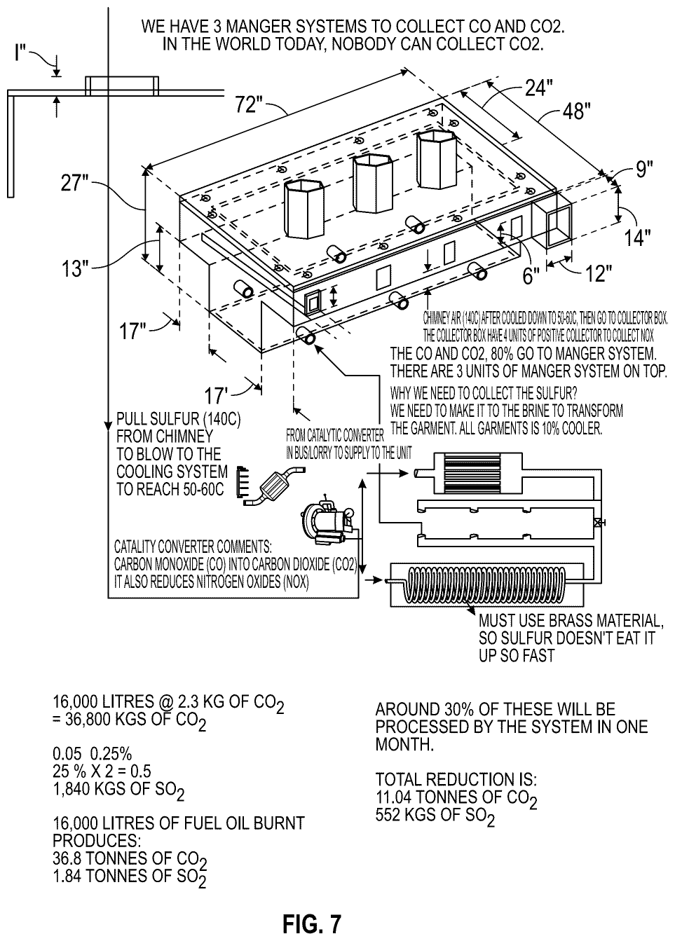

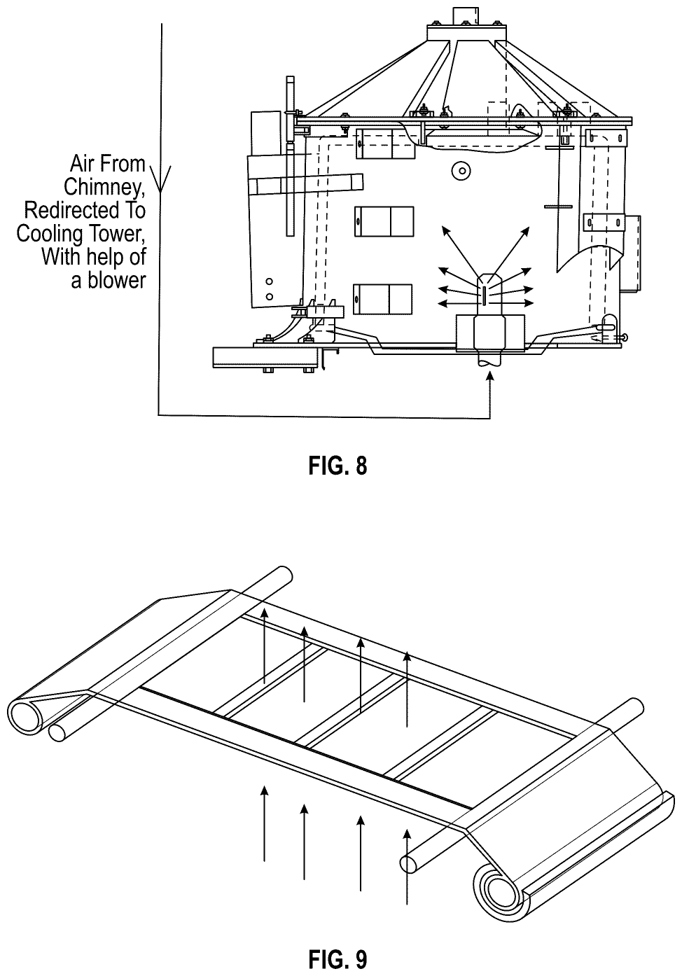

### DETAILED DESCRIPTION

To address the problems of the prior art, a CO2 plasma scrubber device, and related systems, methods and computer-readable medium are provided. Molecules in a stream are negatively charged and the system can be powered by solar or standard small power utility, in some implementations. CO2 can be contained on a CO2 collector pad or other collection mechanism.

In one embodiment, as shown in the figures, a CO2 plasma scrubber system is powered by a reagent exchange process. Using plasma, the CO2 scrubber system is configured to break down and convert pollutants in a gas stream, while also incorporating a mechanism to capture and separate CO2 for storage and other uses. It can extract residue from collectors by soaking into DI water. In one example, ultrasonic testing is used for about 45 minutes to determine carbonate and ultimately 55 gram of CO2 per hour is collected from the plasma scrubber system.

Another figure shows a mechanism for CO2 encapturement, according to an embodiment. An air intake fills molecules into chamber for treatment. The treated molecules exit the encapturement mechanism through multiple exhaust fans. In one implementation, the treatment operation utilizes two anodes on either side of the chamber and conductive brushes proximate to a molecule intake. As a result a negatively charged zone is generated at the input and fed into a positively charged zone, known as the multi anode reaction zone.

Further in the treatment operation, molecules are filtered through a reagent exchange process and an encapturement cartridge. Filtered air can travel through different configurations of tubing connected to the exhaust fans. The tubing can include embedded collectors, for example, with an 8 k watt charge.

One figure snows shows a turbo plasma ionizer device that can incorporate the CO2 plasma scrubber system. One operation for the turbo plasma ionizer device is to disinfect the floor and other areas. In one instance, the device is implemented in a robot that automatically moves and collects CO2.

In another embodiment, as shown in the figures, electrons in CO2 are drawn towards oxygens, so it has partial negative charge. Solar panel or a local AC 220 Volts (20 Watts) can be used with transformer. The CO2 can be absorbed by various mediums, such as solid, liquid, membranes and MOFs. So collector pads can contain CO2 and subsequently processed.

In still another embodiment, as shown in the figures, a turbo plasma ionization CO2 collector provides a (constant) polarity and potential electrostatic footprint in a given space. The system captures CO2 and also viruses, particulates, and other contaminants using an ionizing assisted fan system on negatively charged emitters.

CO2 can be captured and stored using, for example, CCS. The Direct Air Capture (DAC) technology directly captures CO2 from ambient air. The captured CO2 then can be stored or used for various purposes, such as in the production of synthetic fuels or other chemicals.

Advantageously, the impact of CO2 emission on climate change is mitigated. Furthermore, particles, virus, and other contaminants are reduced with minimal disruption.

In other embodiments, sulfur is also extracted, for example, from laundry exhaust.

Specifically, as it pertains to the laundry emissions for the small to medium Industries. Laundry smokestack emissions, unlike the typical factory industrial emissions, can come from the drying process and the chemicals released from laundry products. While often overlooked, these emissions can contain volatile organic compounds (VOCs), including some classified as hazardous air pollutants such as sulfur dioxide (SO2), nitrogen oxides (NOx), and even carcinogens.

In order to allow the industry to achieve 20-30% reduction of harmful emissions from fossil fuel usage we have developed the following technologies for small to medium sized industries.

Typically, in the laundry services industry there is a quite large amount of water required and the use of steam boiler systems to run the washing machines (and drying machines). For example, there can be multiple load sites simultaneously at one time. The more loads of laundry, the more steam required, and up to hundreds of thousands of pounds worth of steam every hour.

### Cooling Tower

Sulfur gas passes through the Chimney @150 C, typically a very difficult temperature to work with. Our unique cooling coil design allows for efficient gas matrix processing. Notice the gas flow through cooling tower via outlets 1, 2, and 3.

Simultaneously, Sulfur, carbon monoxide, and other molecular constituents, along with “sulfur sludge”, are collected.

Some of the unique components:
Negastat filaments, with a 15% air blow-through
Hamburger filaments, with 30% air blow-through
Coiled filaments, with 50% air blow-through

Our Bi-layered rolling sheet design enables the user to unload (roll-off) the supersaturated sheet in 2-layer rolling sheet every week during the service cycle.

The collector to capture NOx. Lastly, Manger system provides the final touches in order to reduce 10% of CO2 through its high-voltage molecular encapturement technology.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

We claim:

1. An air quality scrubber for sulfur and CO2 reduction, the machine comprising:
intaking air exhausted from a chimney;
cooling exhausted air from about 140 C to 50 C or below with a condenser;
forwarding cooled exhaust air through piping from the condenser to a manger;
removing, with the manger, sulfur, CO2 and CO from cooled exhaust air using a reagent exchange process and by entrapping molecules from the cooled exhaust air on a collector pad, wherein the collector pad is electrically charged; and
exhausting cooled ambient air as clean oxygen to the environment, the clean oxygen having CO2 and sulfur contents removed.

2. The machine of claim 1, wherein the chimney exhausts contaminated air.

3. The machine of claim 1, wherein the exhausted air is initially 140 C from energy released from fuel combustion.

4. The machine of claim 1, wherein the manger removes one or more of: CO2, sulfur, and CO, from the exhausted air.
